(19) United States
(12) Patent Application Publication
(10) Pub. No.: US 2026/0298743 A1
(43) Pub. Date: Oct. 1, 2026

(54) WASHER FOR MEASURING FORCE AND DISTRIBUTING FORCE WHEN CONNECTING A CONNECTION MEANS TO A PART TO BE CONNECTED

(71) Applicant: ALTOSENS GMBH, OSNABRUECK (DE)

(72) Inventor: UWE STEINKAMP, OSNABRUECK (DE)

(73) Assignee: ALTOSENS GMBH, OSNABRUECK (DE)

(21) Appl. No.: 19/478,276

(22) PCT Filed: Apr. 24, 2024
(86) PCT No.: PCT/DE2024/200031

§ 371 Date: Oct. 24, 2025

(30) Foreign Application Priority Data
Apr. 26, 2023 (DE) 10 2023 110 704.6

(51) Int. Cl. G01L 5/24; F16B 31/02; G01L 1/14

(52) U.S. Cl. CPC G01L 5/243; F16B 31/028; G01L 1/146

(57) ABSTRACT

A washer for measuring a force and for distributing the force when connecting a connection device to a part to be connected. The washer includes a housing and a force sensor element. The housing has an upper part, a lower part, a cavity arranged inside the housing, and at least one recess which is arranged adjacent to the cavity inside the housing. The force sensor element is arranged in the cavity. The force sensor element has at least one electrode and one dielectric. When the connection device is connected to the part to be connected and an eccentric force is introduced, the washer is reproducibly deformed so that the eccentric force introduced can be reproducibly measured via the force sensor element.

### CROSS REFERENCE TO PRIOR APPLICATIONS

This application is a U.S. National Phase application under 35 U.S.C. § 371 of International Application No. PCT/DE2024/200031, filed on Apr. 24, 2024 and which claims benefit to German Patent Application No. 10 2023 110 704.6, filed on Apr. 26, 2023. The International Application was published in German on Oct. 31, 2024 as WO 2024/223009 A1 under PCT Article 21(2).

### FIELD

The present invention relates to a washer for measuring force and distributing force when connecting a connection device to a part to be connected, wherein the washer comprises a housing having an upper part, a lower part, and a cavity inside the housing, a force sensor element arranged in the cavity, the force sensor element comprising an electrode and a dielectric.

### BACKGROUND

A washer is typically guided over a shank of a screw and serves to transmit the force, proceeding from the bottom of the screw head, in the mounted state, to a larger surface of a part to be connected to the screw. The safety requirements placed on the screw connection are very high, in particular in the case of safety-critical screw connections (category A). This is, for example, the case in wind energy plants in which a reduction of the force or a complete failure of the screw connection may lead to significant consequential costs. Unplanned maintenance work in offshore wind energy plants represent a high cost risk and a high outlay.

The preload force generated in a screw during assembly can be measured indirectly via various tightening methods, such as rotational angle-controlled, yield strength-controlled, hydraulic, thermal, torque-controlled and/or pulse-controlled tightening methods, in order to provide that the required preload force is applied and that the screw connection is not overloaded. This does not, however, allow for a fall below the required preload force or even a failure of the screw connection to be identified during operation. A loss of the preload force during operation may occur, for example, by setting in the contact and support surfaces by levelling of surface unevenness and/or thread flanks. In addition to the laborious manual screw monitoring, it is known to arrange force measurement rings in the screw connection or strain gauges on a screw, or to perform an ultrasound length measurement of the screw. A disadvantage in this case is that this measurement technology must be installed in addition to the actual screw fitting which increases the installation space. A force measurement ring typically has a two to three times greater a height component compared with a standard washer. The diameter of the force measurement ring is also typically larger than the diameter of the corresponding standard washer since a correspondingly larger cavity must be provided for receiving a measuring sensor according to the prior art. Introducing a separate measurement body, such as a force measurement ring, thus increases at least the clamped length of the clamping package. It is as a result typically no longer possible for the original and clear-tested screw combination to be used. The introduction of the separate measurement body into the screw combination furthermore increase the number of joints and thus changes the setting behavior of the screw combination. Introducing a measurement body according to the prior art furthermore significantly reduces the rigidity of the clamping package.

DE 10 2011 005 371 A1 describes a device for monitoring an integrity of a screw connection, wherein a casing is configured as a locking washer and comprises a pressure sensor for recording the pressure of components of a screw connection, when the pressure sensor is arranged between the components of the screw connection and the screw connection is tightened, a computing unit for determining an item of safety information from an item of pressure information of the pressure sensor, and a radio interface for transmitting the safety information to an external reader.

WO 2019/154827 A1 describes a washer unit for use on a screw, wherein the washer unit comprises a washer and a strain detection element, and the strain detection element is arranged inside a passage within a body of the washer, and at least one end of the passage opens to an edge of the body of the washer, and the strain detection element is configured for detecting a strain in the direction of the passage. The strain detection element occupies a length and a width of at least 1 mm to 10 mm in each case, and a height of at least 0.01 mm to at most 1.0 mm. A disadvantage in this case is that, due to the receiving the strain detection element in the passage, the rigidity of the body of the washer is reduced by the passage. A detection of the strain is furthermore only possible in the direction of the passage. Since the at least one passage extends centrally over a height of the body of the washer, it is not possible to detect an eccentric force introduction with the washer unit.

A device for measuring forces is described in DE 41 42 141 A1, which device can be configured in the form of a washer and which comprises a force-reducing means which is associated with a measuring transducer and which provides that only a portion of the force acting overall on the measuring device is applied to the measuring transducer. The force-reducing means configured as a force introduction element surrounds a solid main body in the form of a cylindrical ring, wherein the bottom of the force introduction element rests on the measuring transducer and the measuring transducer is in turn arranged on a carrier plate, which comprises at least one portion that protrudes beyond an outer periphery of the force-introducing means, on which portion reference resistors to the measuring resistors of the measuring transducer are arranged. The measuring device thus does not have the shape and dimensions of a standard washer. The force-reducing means furthermore purposely has a lower spring stiffness than the main body.

DE 10 2019 103 625 A1 describes a force measuring device for measuring and monitoring a preload force of a mechanical connection, wherein the force measuring device comprises two discoid force absorption bodies having a central through-opening for guiding through a threaded rod along a force measuring device longitudinal axis, wherein a plurality of sensor elements are arranged between the two discoid force absorption bodies, which sensor elements are in each case radially spaced from the force measuring device longitudinal axis, and an elastically deformable load element for transmitting the preload applied via the threaded rod from the first to the second force absorption body is arranged between the first and second discoid force absorption body, wherein the sensor elements are arranged in an external load-free region that does not transmit any preload force between the two discoid force absorption bodies, in order to prevent damage to the sensor elements.

DE 10 2016 219 953 A1 describes a device for measuring and/or monitoring the preload force of a mechanical connection which is configured as a flat washer element having a through-opening for the connection element, and comprises a capacitive pressure sensor, wherein the capacitive pressure sensor comprises at least three pressure-sensitive capacitors around the through-opening, and electrical connections, via which capacitances of the capacitor can be detected. The pressure sensor comprises a first board and a second board, between which a dielectric is arranged, wherein, upon tightening of a screw, a pressure force corresponding to the preload force of the screw is exerted on the dielectric of the pressure sensor which causes the spacings between the metal on the two boards to change, which, together with the intermediate dielectric, form a measuring capacitor. A reference capacitor is arranged in a region of the washer element that is not loaded by the screw connection to be measured so that one of the boards protrudes beyond a disc shape and lengthens.

A device for monitoring force-fitting connections with at least one washer-shaped component is described in DE 198 31 372 A1 in which an inner disc is integrated. The inner disc is formed on the outside having a high-strength insulation coating with the exception of a ring, while a measuring layer surrounded by the component is arranged on a bottom of the inner disc.

DE 11 24 729 A describes a device for measuring the forces between components within an assembly comprising a washer that consists of two partial discs and a piezoelectric crystal assembly arranged therebetween. Two sleeves are arranged on the outer and inner periphery, which sleeves act as bourdon tubes so as to press the two partial discs with a preload, under pressure, against the crystal assembly arranged therebetween. Recesses are alternatively arranged opposite on a lateral surface of the upper partial disc, in which sleeve-like projections of the lower partial disc, which extend perpendicularly to the disc surface, are flanged, in order to in turn achieve a preload.

GB 2 394 289 A describes a force-sensitive device for measuring bolt forces, in which a layer of a force-sensitive material is arranged between two force-transmitting, discoid elements. The force-sensitive layer is connected in each case on its top and bottom to an electrode. A space between the two force-transmitting elements around the force-sensitive layer is filled with an additional material.

### SUMMARY

An aspect of the present invention is to improve upon the prior art.

In an embodiment, the present invention provides a washer for measuring a force and for distributing the force when connecting a connection device to a part to be connected. The washer includes a housing and a force sensor element. The housing comprises an upper part, a lower part, a cavity arranged inside the housing, and at least one recess which is arranged adjacent to the cavity inside the housing. The force sensor element is arranged in the cavity. The force sensor element comprises at least one electrode and one dielectric. When the connection device is connected to the part to be connected and an eccentric force is introduced, the washer is configured to be reproducibly deformed so that the eccentric force introduced can be reproducibly measured via the force sensor element.

### BRIEF DESCRIPTION OF THE DRAWINGS

The present invention is described in greater detail below on the basis of embodiments and of the drawings in which:

FIG. 1 is a highly schematic three-dimensional view with a cross-section through a force-measuring washer;

FIG. 2 is a highly schematic sectional view of an alternative to the force-measuring washer shown without a force sensor in the cavity;

FIG. 3 is a highly schematic sectional view of the force-measuring washer from FIG. 2 mounted between a screw head of a screw and a base;

FIG. 4 is a highly schematic sectional view of a further alternative to the force-measuring washer from FIG. 3 with an electrical component and a plug connection;

FIG. 5 is a schematic, three-dimensional view of an alternative to the washer from FIG. 3 in cross-section and in a plan view; and

FIG. 6 is a highly schematic three-dimensional view of an alternative to the washer from FIG. 3 in a side plan view from above.

### DETAILED DESCRIPTION

In an embodiment, the present invention provides a washer for measuring force and distributing force when connecting a connection device to a part to be connected, wherein the washer comprises a housing having an upper part and a lower part, and a cavity inside the housing, and a force sensor element arranged in the cavity, the force sensor element comprising at least one electrode and one dielectric, wherein at least one recess is arranged adjacent to the cavity in the housing so that, when an eccentric force is introduced when the connection device is connected to the part to be connected, the washer can be reproducibly deformed and the introduced force can be reproducibly measured via the force sensor element.

A force-measuring washer is thus provided which is configured to be flat, rigid, and overload-resistant, and which is easy to produce. It is particularly advantageous for the geometric dimensions of the force-measuring washer according to the present invention to be substantially the same as the dimensions of a standard washer. The force-measuring washer can thereby be used directly instead of a conventional standard washer, and allows for continuous measurement of the preload force of a screw connection, both during assembly and also in long-term operation. A conventional washer can therefore be exchanged, in a simple manner and assembly, by a force-measuring washer according to the present invention, even in existing plants, for example, in an offshore wind energy plant. A customer-specific component adaptation, for example, via a wear plate, can also be achieved. The force-measuring washer according to the present invention can therefore be used like a normal, standard washer, both in terms of its dimensions and in terms of its use.

The force-measuring washer distributes the force of a screw head uniformly over the part to be connected, as a support, provides protection of the part to be connected from mechanical damage by the screw, above all during the screwing process, and provides a rigidity which is sufficiently high compared with a rigidity of the screw in order to provide a secure screw connection. The torque during screwing is in this case transmitted to the support without damage to the force-measuring washer. The force-measuring washer is configured to have a small number of joints or even no joints whatsoever in order to prevent setting or creeping of the washer, since this could lead to a loss of the preload force and consequently to the failure of the screw connection.

A force-measuring washer can thereby be provided which is comparable in terms of its geometric dimensions, in particular its height and its outside diameter, to the standardized screw fittings as defined, for example, according to DIN EN 14399, DIN 125 T1, DIN 125 T2, DIN 433 T1, DIN 433 T2, DIN 126, DIN 1440, DIN 1441 and/or DIN 7989. The force-measuring washer can accordingly be formed in all known thread sizes, for example, from M8 to M36, for example, >M36.

A standard washer M30 which has an outside diameter of 55 mm, an inside diameter of 31 mm, and a height of 5 mm, is specified as a reference. A calculated rigidity of 75 kN/μm results if this standard washer is manufactured with hot-dipped galvanized steel. The force-measuring washer according to the present invention has the same inside and outside diameter and the same height as the standard M30 washer without a measuring function. The force sensor element received in the cavity of the housing makes the rigidity of the force-measuring washer according to the present invention only slightly lower, for example, 50 kN/μm, than in the case of the standard M30 washer. The force-measuring washer according to the present invention achieves a high overload resistance therefor, which is in the region of the standard washer with a factor of 10×. Conventional load cells, for example, with strain gauges which, with a height of 16 mm and an outside diameter of 72 mm, significantly exceed the height of 5 mm and the outside diameter of 55 mm of the force-measuring washer according to the present invention and the standard M30 washer; the low rigidity of 9.9 kN/μm and the lower overload resistance of 1.5× of the force-measuring washer according to the present invention also significantly exceeds the conventional load cell.

The force-measuring washer according to the present invention also offers the advantages of direct measurement of the screw preload force, the possibility of anticipatory maintenance, the determination of the remaining service life, and the diagnosis capacity of the state of the screw connection, even during operation. There is also the option of sensor-integrated measurement data management and thus the evaluation of the measurement data directly in the force sensor element via a microprocessor and memory.

The substantially installation space-neutral integration of the force sensor element makes the component rigidity, if at all, only slightly less than in the case of a standard washer, and a high overload resistance with a factor of 10× the nominal load range can be achieved.

The fact that at least one recess is arranged adjacent to the cavity inside the housing, wherein the force sensor element is received in the cavity, provides that even when an eccentric force is introduced during screwing, the washer deforms reproducibly and the introduced eccentric force is reproducibly measured via the force sensor element.

An essential concept of the present invention is based on a washer being configured directly as a force gauge so that its geometric dimensions, due to the installation space-neutral integration of the force measurement sensor, are identical or at least substantially the same as the corresponding standard washer, and a targeted spatial arrangement of at least one additional recess adjacent to the cavity in which the force sensor element is received also allows for an eccentric measurement. Due to the fact that the force-measuring washer does not comprise a separate measurement body, the number of joints, and thus the setting behavior of the screw combination, is reduced and a high rigidity and overload resistance is provided. The continuous detection of the preload force during screwing makes it possible for a low dispersion of the preload force to be achieved irrespective of the tightening method (tightening factor 1.0). Due to the at least one recess adjacent to the cavity, slight load changes can be easily detected despite high preloads, and a high level of sensitivity, for example, of E=1.96 E-07 mm, can be achieved.

The following is explained with regard to terminology:
A “washer” is in particular an annular disc that can be pushed over a shank of a connection device. During connection and during operation, the washer is in particular arranged between a screw head or a nut and a part to be connected. The washer is in particular a force-measuring washer and also serves, in addition to transmitting the force proceeding from an underside of a screw head or a nut to a typically larger surface of a part to be connected, to measure the preload force, introduced force, and/or pressure force. The washer can also be integrated directly in a screw, for example, if the screw has a larger or round head. The washer in particular has a larger outside diameter than the screw head or the nut. The washer is in particular a standardized washer and corresponds, in terms of its dimensions, to the above-mentioned DIN regulations. The washer in particular has an outside diameter in a range of 1.8 to 2 times the hole diameter for metal connections. For wood connections, the washer in particular has an outside diameter/hole diameter ratio of approximately 3:1. The washer in particular has a height in a range of 0.3 mm to 12 mm, depending on the standard size. The height of the washer, as a standard M30 washer, is, for example, in a range of 4.0 mm to 6.0 mm, for example, of 4.5 mm to 5.5 mm. As a material, the washer can in particular comprise metal, such as brass, steel, and/or stainless steel. The washer can also be hot-dip galvanized. The washer can also comprise other metals, such as aluminum, and/or copper. The washer may also comprise a plastics material, for example, polyamide, or be produced entirely from a plastics material.

A “housing” is in particular a solid cover of the washer. The housing in particular comprises an upper part and a lower part. A cavity for receiving the force sensor element is arranged in the housing, in particular on the inside. In the case of connection, the top of the upper part is in particular in contact with the connection device, and the bottom of the lower part rests on the part to be connected. It should in principle be emphasized that the terms upper part and lower part here serve only for distinction, and that the washer can in principle also be used rotated about 180° so that, in the case of a connection, the lower part rests on the connection device and the upper part rests on the part to be connected. The upper part can in particular be configured as a housing cover and the lower part as a housing base. The upper part and/or the lower part can also partially or completely form an inside wall of the washer at the inside diameter, and/or an outside wall of the washer at the outside diameter. The upper part or the lower part is in particular configured as a force introduction punch. In order to prevent a rotational relative movement, and thus in order that the force sensor element is not damaged by the transmitted torque during the assembly process, the upper part is rigidly connected to the lower part. The connection of the upper part and the lower part can be achieved, for example, via press-fitting, laser welding, and/or a similar connection method. The upper part and the lower part in particular comprise metal, for example, stainless steel, and are thus electrically conductive.

A “force sensor element” (also “force measurement sensor”) is in particular any type of sensor and/or sensing element via which a force introduction can be measured. A force sensor element is in particular a pressure sensor. The force sensor element can, for example, be a capacitive pressure sensor which operates based on a change in the electrical capacitance of at least one individual capacitor. In the case of a design as a capacitive pressure sensor, the capacitance change is in particular evaluated as a sensor effect based on a sagging of a membrane and/or a dielectric with the resulting change in a plate spacing of an electrical capacitor, for example, configured as two electrodes. The upper part or the lower part in particular serves as one of the two electrodes of the capacitive pressure sensor. The force sensor element is in particular of a height in a range of 0.30 mm to 1.50 mm, for example, in a range of 0.54 mm to 1.25 mm. The force sensor element in particular has a surface area requirement of 2.81 mm² to 515.22 mm² or a sensor volume of 1.51 mm³ to 644.02 mm³. A printed circuit board (PCB) or a multilayer film can in particular be used as the semi-finished product of the force sensor element.

A “dielectric” is in particular understood to be an electrically weakly or non-conductive substance in which charge carriers that are present are not freely movable. The dielectric is in particular configured as a solid. The dielectric is in particular an insulating material. The dielectric in particular comprises a plastics material, for example, an elastomer. The dielectric comprises as a material, for example, silicone, natural rubber, polyethylene, or LCP (liquid crystal polymer). The dielectric is in particular of a height in a range of 0.01 mm to 0.40 mm, in particular of 0.04 mm to 0.25 mm, for example, of 0.1 mm to 0.20 mm. A layer of the dielectric is in particular arranged between the electrode and the housing and serves both for insulation and also as a bump stop and as a rigidity element. The dielectric has a surface area of 200 mm² in the case of the design of the force-measuring washer as a standard M30 washer.

An “electrode” is in particular an electron conductor. The electrode in particular comprises an electrical conductor, for example, metal or graphite. The electrode in particular interacts with a counter electrode, wherein the counter electrode can be configured as an upper part or as a lower part. The electrode and/or the counter electrode can also be configured as a metallization. The electrode is in particular electrically insulated from the housing of the washer. The electrode can, for example, be configured as a metallization on a printed circuit board (PCB). The electrode together with the dielectric can alternatively also be configured as a multilayer film.

The washer can optionally also comprise at least one electronic component for sensor-integrated digitalization and/or data processing, a transmitter, and/or a plug connection for an external communication.

A “cavity” is in particular a recessed space, filled with the sensor force element, in the interior of the housing of the washer. The force sensor element is in particular arranged in an exactly fitting manner in the cavity of the housing of the washer.

A “recess” is in particular an incision in an inner surface of the housing. The recess can, for example, be provided in the inside in a surface of the upper part and/or the lower part. The at least one recess can also be arranged partially or completely in an inside wall around the cavity. The at least one recess can likewise be arranged at a transition between the inside wall on the cavity and the upper part or lower part. The washer can in particular comprise two or more recesses adjacent to the cavity. The feature whereby “the at least one recess is arranged adjacent to the cavity in the housing” is understood to mean that the recess is formed directly adjacent to the cavity. The recess is thus in direct contact with the cavity, and the respective recess and the cavity form a hollow. The recess can be of any shape, for example, the recess is cut into the surface of the housing in a V-shaped, semicircular, circular or oval manner. The recess can, however, also be rectangular, square, polygonal, or curved. In addition to its shape, the recess can likewise also be configured to be flexible in terms of its size and dimension. The recess is in particular configured so that when an eccentric force is introduced, the washer and/or the dielectric deforms reproducibly and the introduced eccentric force can be reproducibly measured via the force sensor element. The recess and/or the recesses is or are in particular filled with air.

An introduced eccentric force can also be reproducibly measured via the force sensor element in the case of a single recess which is arranged on the outside on a radius R2 of the washer and the spacing da of which can be configured as the center point of the washer with respect to center point of the radius R2, and the location of which can be configured as for the embodiment described below with two mutually spaced recesses. For this purpose, the single recess is formed having a reduced height H_{da}=H−R2, which is the remaining material thickness of the washer between the recess R2 and an annular outer surface of the washer, wherein the height H is the constant material thickness between the cavity free of the recess and the annular outer surface of the washer. The reduced height H_{da} is set so that a rigidity at the radius at the position R2 is the same as a rigidity at a radius at an inner position R1 free of a recess at the cavity (R1 equal to zero compared with the embodiment described below having two mutually spaced recesses). In the case of the washer as a standard M30 washer, for example, H=2.10 mm and R2=0.55 mm, so that the reduced height H_{da}=1.55 mm at an identical rigidity of 243 kN/μm. This rigidity is in particular due to a very small volume of the force sensor element of 1.52 mm³ and a height of the force sensor element of only 0.6 mm. In the case of the washer as a standard M10 washer, for example, H=0.60 mm and R2=0.19 mm, so that the reduced height H_{da}=0.41 mm at the same rigidity of approximately 23 kN/μm.

In the case of a single outer recess, a volume is thus purposely reduced by the recess at the position R2 in a range of 5.00% to 20.0% in order to at least reduce or to completely eliminate an influence of an eccentric force introduction during the force measurement. In the case of the washer as a standard M30 washer, the percentage volume reduction of solid material of the washer by the single recess at the position R2 is, for example, 6.9%, in the case of a standard M10 washer 10.0%, and in the case of a standard M36 washer 6.3%.

In an embodiment of the washer of the present invention, two recesses that are radially spaced from one another can, for example, be arranged adjacent to the cavity.

The force sensor element can thereby also provide reproducible measured values if, due to fluctuating diameter tolerances of the screws and/or the washer, an exact centering of the components to be interconnected cannot be provided. The force-measuring washer and/or the force sensor element is insensitive to eccentric mounting due to the two recesses that are racially spaced from one another.

The two recesses that are radially spaced from one another and are adjacent to the cavity are formed in the housing, the upper part and/or the lower part so that, when a force is introduced onto the upper part or the lower part, the upper part or the lower part deforms reproducibly irrespective of the screw position and depending on the introduced force. The upper part, as the part on which the force is introduced, can, for example, be configured as a punch therefor.

In order to further increase the measuring accuracy, the two recesses that are radially spaced from one another have different cavity volumes so that a respective rigidity of the housing at the two radially spaced recesses is essentially the same.

In order to implement a plane-parallel displacement of the force introduction punch (upper part or lower part), the radius R1 of the first, further inwardly located recess, and the radius R2 of the second, further outwardly located recess, are configured so that the rigidity at the position R1 is identical to the rigidity at the position R2. The ratio of the spacings of the radii of the two recesses is ideally:

$$\frac{da}{di} = \frac{R 1 ( H - R 1 )}{R 2 ( H - R 2 )}$$

where da=spacing of the center point of the washer from the center point of the radius R2, di=spacing of the center point of the washer from the center point of the radius R1, and H=height of the washer.

The two recesses that are radially spaced from one another have different cavity volumes corresponding to the local rigidities to be set.

In the case of the washer as a standard M30 washer, the inner recess in particular has a radius R1 in a range of 0.0 mm to 2.0 mm, a maximum diameter in a range of 35.0 mm to 39.0 mm, and a maximum height in a range of 1.5 mm to 2.7 mm. The outer recess in particular has a radius R2 in a range of 1.0 mm to 2.5 mm, a maximum diameter in a range of 40.0 mm to 46.0 mm, and a maximum height in a range of 1.5 mm to 2.7 mm. The spatial location of the inner recess at the position R1 is in particular in a range of the spacing di of 1.1*ri<di<1.2*ri, where ri is equal to the inside radius of the washer, wherein the inside radius ri rests directly on the central hole diameter of the washer. The spatial location of the outer recess at the position R2 is in particular in a range of the spacing da of 0.8*ra<da<0.9*ra, where ra is equal to the outside radius of the washer. In the case of a standard M30 washer, for example, di=36.95 mm and da=50.06 mm.

The radii ratio R1/R2 of the two recesses can, for example, be less than 1 in order to achieve an improvement in the reproducibility of the force sensor element in the case of an eccentric introduction of force.

The inner recess can, for example, have a smaller cavity volume than the recess located further towards the outside. The measuring surface of the force sensor element is in particular located substantially between the two recesses. If R1 and R2 are the same, and thus also the wall thicknesses, then on account of the larger outside diameter of the recess located further towards the outside, a greater moment of resistance and, resulting therefrom, a greater rigidity, would emerge. The suitable selection of the radii ratio and/or the cavity volume of the respective recess compensates the greater moment of resistance so that the existing rigidities at the two recesses are the same.

The overall rigidity in principle results from the sum of the individual rigidity of the housing and the individual rigidity of the force sensor element. In order to increase the housing rigidity, the force sensor element is configured so that the height and the diameter of the cavity, in which the force sensor element is received, is minimized. The minimization of the cavity can in particular be set by the height of the dielectric, the permittivity of the dielectric, and/or the selection of the sensor element semi-finished product. The housing rigidity is set by width of the at least one recess and its position in the washer, or the width and the radii R1 and R2 of the two recesses that are radially spaced from one another. The smaller the height of the dielectric, the smaller the width of the respective recess and the radii R1 and R2 can be implemented.

The washer can in principle, for example, be configured so that it has, as closely as possible, the known mechanical properties of a conventional standard washer. In particular a small volume of the cavity for the force sensor element and a small volume of the recess or the recesses is thereby advantageous, so that a single recess can accordingly be provided instead of two spaced recesses.

In an embodiment of the washer of the present invention, the cavity can, for example, be arranged in the upper part and/or between the upper part and the lower part.

When the cavity in which the force sensor element is received is arranged in the upper part, the respective recess can, for example, be arranged in the bottom side of the upper part directly adjacent to the cavity. Since the washer is symmetrical, instead of being formed in the upper part, the cavity can also be formed in the lower part so that the respective recess is made in a corresponding manner in the inner surface of the lower part. The cavity can likewise be formed between the upper part and the lower part, or partially in the upper part and partially in the lower part.

In order to improve the overload resistance of the force sensor element, the force sensor element is arranged in a force-fitting and/or form-fitting manner in the cavity, at least laterally substantially transversely to an axial force direction.

The force-fitting and/or form-fitting installation of the force measuring sensor in the cavity at least laterally, and thus in the radial direction, limits occurring tensile loads substantially transversely to the axial force direction, which tensile loads occur when the force sensor element is loaded with pressure when the force is introduced. The at least laterally flush fitting of the force sensor element in the cavity of the housing minimizes an extension in the transverse direction relative to the axial force direction, and thus a tensile loading of the components of the force sensor element. A friction coefficient between the force sensor element and the housing is already sufficient in the case of the force sensor element being formed with a multilayer film. The force sensor element can optionally or additionally also be installed in a force-fitting and/or form-fitting manner in the cavity at its top and/or bottom side, in the axial force direction.

The axial force as well as bending and tilting moments, which are introduced onto the outer surface of the upper part of the housing, as an area load, when the force is introduced, are thus transmitted from there via the force sensor element and conveyed into the lower part of the housing. The overload resistance of the housing is thereby absorbed by the force sensor element and the force sensor element acts as a stop.

The “axial force direction” is in particular the direction directly transverse to the diameter of the washer. The axial force direction is in particular also a direction along or in parallel with the longitudinal central axis of the connection device, for example, a screw, which is guided through the central opening of the washer. The “axial force direction” is in particular also the direction of the force introduction in the case of connection.

“Laterally substantially transversely to an axial force direction” means that the force sensor element need not be oriented with its inner and outer side walls exactly perpendicular to the axial force direction and arranged in the cavity.

“Form-fitting” is in particular understood to mean that the two connection partners engage in one another. The engagement of the force sensor element and the inside wall or shaping of the cavity thus prevents at least a lateral movement of the force sensor element. In the case of, for example, a form-fitting connection, the active surfaces of the force sensor element and one inside wall of the cavity are subjected to surface pressure. In the case of a form-fitting connection, the configuration of at least one inside wall of the cavity in particular blocks the movement of the force sensor, or vice versa.

“Force-fitting” is understood to mean that a normal force is present on the surfaces to be interconnected. The mutual displacement of an outside surface of the force sensor element and an inside surface of the cavity is in particular prevented as long as a counterforce, acting by the static friction, is not exceeded. In particular the static friction between the active surfaces in this case means that a lateral displacement of the force sensor element in the cavity takes place.

The form-fitting and/or force-fitting connection between an outside surface of the force sensor element and the inside surface around the cavity thus prevents or at least minimizes a tensile elongation of the force sensor element transversely to the axial force introduction direction.

In an embodiment of the present invention, the washer, in particular configured as a standard M30 washer, can, for example, have a rigidity in a range of 30.0 kN/μm to 70.0 kN/μm, in particular of 40.0 kN/μm to 60.0 kN/μm, for example, of 45.0 kN/μm to 55.0 kN/μm.

A force-measuring washer is thus provided which has the from of a conventional washer and only a slightly reduced or increased rigidity, for example, compared with an M30 standard washer at 75 kN/μm. These value ranges of the rigidity in particular apply for a large volume of 644.0 mm³ and a large height of 1.25 mm of the force measuring sensor.

In order to form the upper part as a punch and/or to purposely limit a tensile load of the force sensor element in the lateral, radial direction, the upper part forms an outside surface and/or an inside surface of the washer, in part or completely.

In an embodiment of the washer of the present invention, the force sensor element can, for example, have a height in a range of 5.0% to 40.0%, in particular of 10.0% to 30.0%, for example, of 15.0% to 25.0%, of a height of the washer, and/or the washer has a height in a range of 90.0% to 110%, in particular of 95.0% to 105.0%, for example, of 98.0% to 102.0%, of a standard washer of the same outside diameter.

The clamped length of the connection clamping package thus corresponds to that of an original and clear-tested screw fitting.

In order to achieve the required rigidity and overload resistance, the dielectric has a relative permittivity in a range of 0.5 to 100.0, in particular of 1.0 to 80.0, for example, of 2.5 to 10.0.

The geometry, the material, and thus the properties of the dielectric are matched for the rigidity of the housing so that the rigidity of the dielectric, up to a specified value in a range of 30% to 80% of the nominal load range of the washer, is less than the rigidity of the housing. The housing of the washer thus substantially contributes to the system rigidity in this range. After the specified value in a range of 30% to 80% of the nominal load range up to the overload range, the dielectric conducts an increasing fraction of the force to the housing lower part and thereby prevents a permanent deformation of the washer and consequently a destruction of the force sensor element.

In an embodiment of the washer of the present invention, the dielectric can, for example, have a modulus of elasticity in a range of 0.2 MPa to 12,000 MPa, in particular of 30.0 MPa to 5,000 MPa, for example, of 60.0 MPa to 1,500 MPa.

The rigidity of the force sensor element and as a result the overall rigidity of the washer can thus be set via the E-modulus of the dielectric. The higher the E-modulus of the dielectric, the less the elongation of the force sensor element in the case of an introduced force in the axial force direction, and consequently the higher the rigidity of the force sensor element. In the case of the dielectric being formed of LCP (liquid crystal polymer) having an E-modulus of 11,700, the elongation in the force direction is 0.19 mm in the configuration as an M30 standard washer. In the case of the dielectric being formed of natural rubber having an E-modulus of 64.5, the elongation in the force direction is already 34.88 mm.

The “relative permittivity” of the dielectric (also referred to as dielectric constant) is in particular the dimensionless ratio of the permittivity of the dielectric to the permittivity of a vacuum. The permittivity in particular generally specifies the polarization capacity of a material by electric fields. The permittivity in particular specifies the electrically insulating material property of the dielectric.

The “modulus of elasticity” (also referred to as E-modulus) in particular describes in the case of linear/elastic behavior the proportional relationship between the voltage and elongation in the case of deformation of the dielectric. The elasticity modulus in particular increases with the resistance with which a material and/or the dielectric counters its electrical deformation. The higher the modulus of elasticity, the more rigid the dielectric.

The washer can optionally comprise an additional electronic component, for example, in order to transmit the measured data of the force sensor element externally to data processing via RFID or via another wireless communication device. Digitalization and an evaluation unit can, however, also be integrated directly in the force sensor element or in the washer. The washer can also comprise a plug connection on its outer periphery for reading out data and for communication. The electronic component and/or the plug connection can in this case protrude radially outwards beyond the outside diameter of the washer in a small region of the periphery.

Communicative connection between the force-measuring washer and an external data processing and evaluation system and/or a cloud-based state monitoring system makes it possible for the provided measured data to be used for temporal trend analyses, targeted monitoring of structural loads and/or mechanical operating load, calculation of the remaining service life of the facility in which the force-measuring washer is used, and/or for anticipatory maintenance planning. The servicing and maintenance costs are reduced as a result and unplanned maintenance work is avoided. Early detection of damage and determination of damage progress also is made possible for determining the optimal maintenance interval. Unplanned downtimes, for example, in the case of offshore wind energy plants, are thereby minimized.

The present invention will be explained in greater detail below with reference to embodiments as shown in the drawings.

A force-measuring washer 101 comprises an upper part 103 having a top side 105 and a lower part 107 having a bottom side 109, each formed from stainless steel. The upper part 103 entirely forms a lateral outside wall 129. An inside wall 131 is formed partially by the upper part 103 and the lower part 107. The upper part 103 and the lower part 107 are welded together and form the housing of the force-measuring washer 101. A cavity 111 is formed in the upper part 103, on the inside in the force-measuring washer 101. An inner recess 125 is formed directly adjacent to the cavity 111 in an inside side wall of the lower part 107, around the cavity 111, and an outer recess 127 is formed in an inside surface of the upper part 103. The inner recess 125 and the outer recess 127 are filled with air. A force sensor 113 is arranged flush in the cavity 111 and is clamped laterally in a force-fitting manner between the inner side walls of the upper part 103 and of the lower part 107.

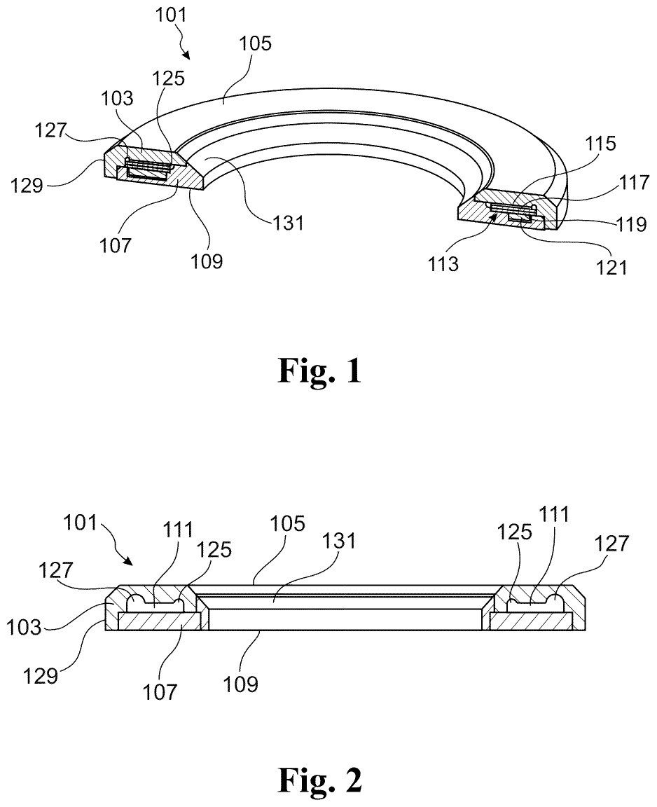

The force sensor 113 comprises an electrode 115 which is arranged on a dielectric 117, and a printed circuit board 119. The electrode 115 and the dielectric 117 are configured as a multilayer film. The dielectric 117 serves as an insulator with respect to the electrode 115 and as a bump stop and rigidity element. The force-measuring washer 101 also comprises an electronic component 121 for sensor-integrated digitalization and data processing, wherein the electronic component is arranged inside the lower part 107 (see FIG. 1).

The force-measuring washer 101 has an outside diameter of 55 mm, an inside diameter of 31 mm, and a height of 5 mm, and thus corresponds in its dimensions to an M30 standard washer.

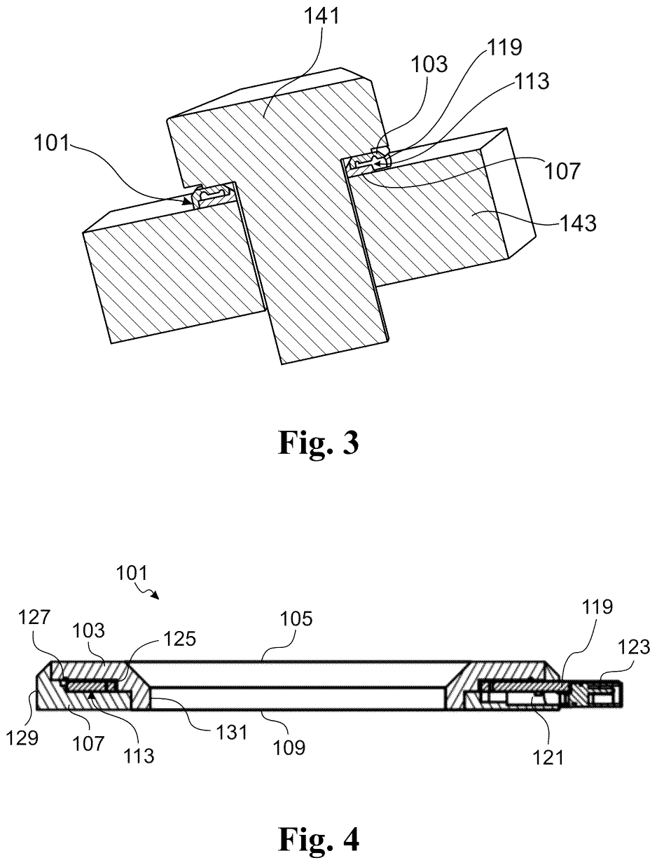

The force-measuring washer 101 is pushed, with its inside free diameter, over the shank of a screw (not shown in FIG. 1), and the screw is screwed into a base (likewise not shown; see FIG. 3). Due to manufacturing tolerances, a force introduction onto the top side 105 of the upper part 103 takes place slightly eccentrically during screwing, wherein a force of 450 kN is introduced. Due to the radially spaced inner recess 125 and the outer recess 127, which have approximately the same rigidities, the force sensor 113 reproducibly measures the introduced force, despite the slightly eccentric force introduction, wherein, due to the pressure force, a deformation of the dielectric 117, and as a result, a change in the spacing between the electrode 115 and a second metallization applied to the printed circuit board 119, occurs. A force-measuring washer 101 is thus provided which provides a high overall rigidity, a high overload resistance, and a reproducible pressure measurement via the force sensor 113.

FIG. 2 shows an alternative force-measuring washer which has a similar design to that described above. The inner recess 125 and the outer recess 127 adjacent to the cavity 111 are, however, here both formed in the bottom side of the upper part 103 (FIG. 2 shows the cavity 111 without the force sensor 113). The inner recess 125 and the outer recess 127 are semicircular in cross-section. The outer recess 127 has a larger cavity volume than the inner recess 125 in order to provide approximately the same rigidity at the respective center of the respective recess 125, 127. The cavity 111 is also here formed entirely in the upper part 103. The upper part 103 is in turn configured as a force-introduction punch and occupies the entire outside wall 129 and part of the inside wall 131 of the force-measuring washer 101. As described above, the force-measuring washer 101 also comprises a force sensor 113 having a printed circuit board 119 (see FIG. 3). In a short region on the outside wall 129, the printed circuit board 119 penetrates the outside wall 129 and has a plug connection (not shown in detail in FIG. 3) for external communication.

FIG. 3 shows the force-measuring washer 101 from FIG. 2 in a mounted state in which a screw 141 presses with its screw head on the top side 105 of the upper part 103 of the force-measuring washer 101, and the bottom side 109 of the lower part 107 of the force-measuring washer 101 rests on a base 143. A continuous measurement of the pressure force on the force-measuring washer 101 is acquired in the mounted state via the force sensor 113, and thus allows long-term monitoring of the screw connection.

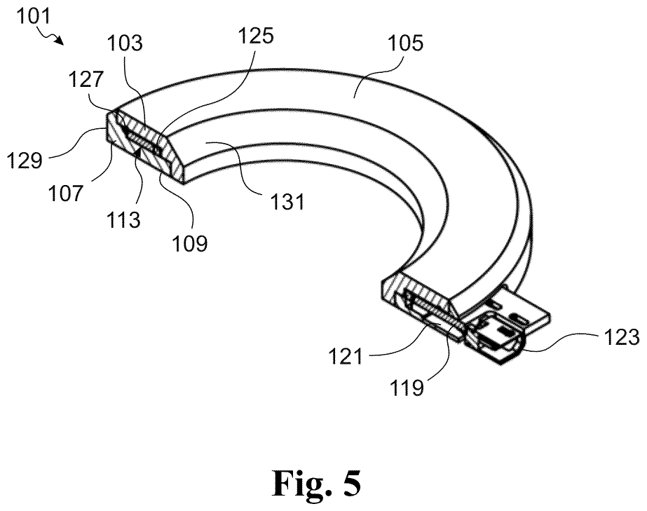

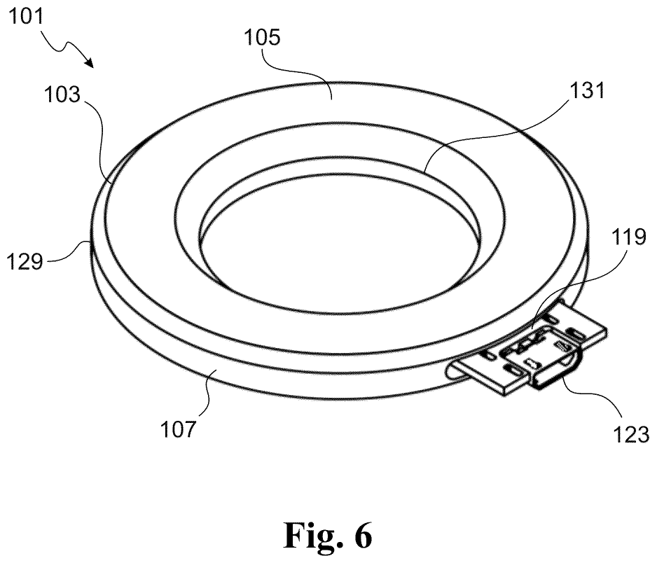

In a further alternative of the force-measuring washer 101 shown in FIGS. 4 to 6, the lower part 107 forms an outside wall 129, and the upper part 103 entirely forms the inside wall 131. In this alternative, the inner recess 125 is formed beside the pressure sensor 113 and thus as a lateral extension of the cavity 111, while the outer recess 127 is formed between the lower part 107 and the upper part 103. As described above, the washer 101 comprises a force sensor 113 having a printed circuit board 119 which in part penetrates the outside wall 129, in a short region, and there comprises a plug connection 123 for outside communication (FIGS. 5 and 6). The washer 101 also comprises an electronic component 121 for measured value acquisition and evaluation. When the force-measuring washer 101 is used in an offshore wind energy plant, the stored measured values from the force-measuring washer 101 can thus be read out by the electronic component 121 by connecting an external laptop to the plug connection 123.

Force-measuring washers 101 are thus provided which have the same dimensions as the corresponding standard washer and thus allow for use of conventional screw fittings, wherein the force-measuring washers provide high rigidity, high overload resistance, and high measuring accuracy.

The present invention is not limited to embodiments described herein; reference should be had to the appended claims.

### LIST OF REFERENCE NUMERALS

101 force-measuring washer
103 upper part
105 top side
107 lower part
109 bottom side
111 cavity
113 force sensor
115 electrode
117 dielectric
119 printed circuit board
121 electronic component
123 plug connection
125 inner recess
127 outer recess
129 outside wall
131 inside wall
141 screw
143 base

What is claimed is:

1-10. (canceled)

11. A washer for measuring a force and for distributing the force when connecting a connection device to a part to be connected, the washer comprising:
a housing comprising an upper part, a lower part, a cavity arranged inside the housing, and at least one recess which is arranged adjacent to the cavity inside the housing; and
a force sensor element which is arranged in the cavity, the force sensor element comprising at least one electrode and one dielectric,
wherein,
when the connection device is connected to the part to be connected and an eccentric force is introduced, the washer is configured to be reproducibly deformed so that the eccentric force introduced can be reproducibly measured via the force sensor element.

12. The washer as recited in claim 11, wherein,
the at least one recess comprise two recesses, and
the two recesses are arranged adjacent to the cavity radially spaced apart from one another.

13. The washer as recited in claim 12, wherein the two recesses have different cavity volumes so that a rigidity of the housing at the two recesses is substantially the same.

14. The washer as recited in claim 11, wherein the cavity is arranged at least one of in the upper part and between the upper part and the lower part.

15. The washer as recited in claim 11, wherein the force sensor element is arranged in at least one of a force-fitting and a form-fitting manner in the cavity at least laterally substantially transversely to an axial force direction.

16. The washer as recited in claim 11, wherein the washer has a rigidity of from 30.0 kN/μm to 70.0 kN/μm.

17. The washer as recited in claim 16, wherein the washer is configured as a standard M30 washer.

18. The washer as recited in claim 11, wherein the upper part in part or completely forms at least one of an outside surface of the washer and an inside surface of the washer.

19. The washer as recited in claim 11, wherein at least on of,
the force sensor element has a height of from 5.0% to 40.0% of a height of the washer, and
the washer has a height of from 90.0% to 110% of a height of a standard washer having a same outer diameter.

20. The washer as recited in claim 11, wherein the one dielectric has a relative permittivity of from 0.5 to 100.0.

21. The washer as recited in claim 11, wherein the dielectric has a modulus of elasticity of from 0.2 MPa to 12,000 MPa.
